(19) United States
(12) Patent Application Publication
(10) Pub. No.: US 2014/0192182 A1
(43) Pub. Date: Jul. 10, 2014

(54) METHOD FOR VIEWING VIRTUAL OBJECTS WITHIN AN APPLIANCE

(71) Applicant: GENERAL ELECTRIC COMPANY, Schenectady, NY (US)

(72) Inventor: Keith Wesley Wait, Louisville, KY (US)

(73) Assignee: GENERAL ELECTRIC COMPANY, Schenectady, NY (US)

(21) Appl. No.: 13/738,206

(22) Filed: Jan. 10, 2013

(51) Int. Cl. H04N 7/18

(52) U.S. Cl. CPC H04N 7/18
USPC 348/121

(57) ABSTRACT

A method for viewing virtual objects within or on an appliance is provided. The method includes recording an image of the appliance and a positional reference disposed on a surface of the appliance. The method also includes generating a modification of the image. The modification illustrates the appliance and a virtual object disposed adjacent the positional reference.

### FIELD OF THE INVENTION

The present subject matter relates generally to methods for viewing virtual objects, such as virtual food items, within an appliance, such as a refrigerator appliance.

### BACKGROUND OF THE INVENTION

Appliances can be sold within retail stores that include numerous types, brands, and configurations of appliances. For example, such retail stores can display and sell multiple refrigerator appliance models from multiple refrigerator appliance manufacturers. Due to the number of appliance choices at such retail stores, marketing any particular appliance amongst the numerous other appliances can be difficult.

Thus, methods for better marketing an appliance would be useful. In particular, methods for distinguishing a particular appliance from amongst numerous other appliances would be useful.

In addition, appliance customers can have difficulty selecting an appliance amongst the numerous appliances at retail stores. At such retail stores, appliances can appear similar when they are lined up next to one another. The appliances are also generally empty. For example, refrigerator appliances generally don't have food items stored within the refrigerator's chilled chamber at such retail stores. Thus, appliance customers can have difficulty visualizing how the appliance will operate and function, e.g., how many food items will fit within the refrigerator's chilled chamber and where particular food items will fit within the chilled chamber.

In order to permit appliance customers to experience the look and feel of certain appliances during use of the appliance, prop items can be placed within the appliances. For example, prop food items can be loaded in a refrigerator appliance's chilled chamber in order to show appliance customers how food items fit within the chilled chamber. However, such props can be vandalized or stolen.

Accordingly, methods for assisting appliance customers with experiencing how appliances will operate and function would be useful. In particular, methods for assisting appliance customers with experiencing how appliances will operate and function without using prop items would be useful.

### BRIEF DESCRIPTION OF THE INVENTION

The present subject matter provides a method for viewing objects within or on an appliance. The method includes recording an image of the appliance and a positional reference disposed on a surface of the appliance. The method also includes generating a modification of the image. The modification illustrates the appliance and a virtual object disposed adjacent the positional reference. Additional aspects and advantages of the invention will be set forth in part in the following description, or may be apparent from the description, or may be learned through practice of the invention.

In a first exemplary embodiment, a method for viewing virtual food items within a refrigerator appliance is provided. The refrigerator appliance has a housing that defines a chilled chamber for receipt of food items for storage and a positional reference disposed within the chilled chamber of the refrigerator appliance. The method includes receiving an image of the chilled chamber of the refrigerator appliance and the positional reference disposed within the chilled chamber from a camera, generating a modification of the image, and determining a position and an orientation of the positional reference within the image. The modification illustrates the chilled chamber of the refrigerator appliance and a virtual food item disposed adjacent the positional reference within the chilled chamber. The method also includes presenting the modification of the image on a display device.

In a second exemplary embodiment, a system for viewing virtual food items within a refrigerator appliance is provided. The refrigerator appliance has a housing that defines a chilled chamber for receipt of food items for storage and a positional reference disposed within the chilled chamber of the refrigerator appliance. The system includes a mobile device with a camera for producing images and a display for viewing images produced by the camera. The mobile device also includes one or more processors and at least one memory coupled to the one or more processors. The at least one memory includes computer-readable instructions for execution by the one or more processors to cause the one or more processors to perform operations. The operations include recording an image of the chilled chamber of the refrigerator appliance and the positional reference disposed within the chilled chamber with the camera, determining a position and an orientation of the positional reference within the image, modifying the image by placing a virtual food item adjacent the positional reference within the chilled chamber within the image, and displaying the modified image with the virtual food item on the display.

In a third exemplary embodiment, a computer-readable medium having computer-readable instruction for execution by a processor is provided. The computer-readable instruction causes the processor to perform operations. The operations include receiving an image of an appliance and a positional reference disposed on a surface of the appliance from a camera, determining a position and an orientation of the positional reference within the image, and generating a modification of the image. The modification illustrates the appliance and a virtual object disposed adjacent the positional reference. The operations also include presenting the modification of the image on a display device.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a front, elevation view of a refrigerator appliance according to an exemplary embodiment of the present subject matter.

FIG. 2 provides a front elevation view of the refrigerator appliance of FIG. 1 with refrigerator doors of the refrigerator appliance shown in an open position to reveal a fresh food chamber of the appliance. Positional references are mounted at various locations within the chilled chamber.

FIG. 3 provides a front elevation view of the refrigerator appliance of FIG. 2 with a mobile device shown directed at the refrigerator appliance.

FIG. 4 provides a front elevation view of the refrigerator appliance of FIG. 2 with the mobile device shown displaying a modified image of the fresh food chamber of the refrigerator appliance on a display of the mobile device. The modified image includes a virtual food item positioned within the chilled chamber at one of the positional references.

FIG. 5 illustrates a schematic view of the mobile device of FIG. 3 according to an exemplary embodiment of the present subject matter.

FIG. 6 illustrates a method for viewing virtual food items within a refrigerator appliance according to an exemplary embodiment of the present subject matter.

FIG. 7 illustrates a method for viewing virtual objects within an appliance according to an exemplary embodiment of the present subject matter.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

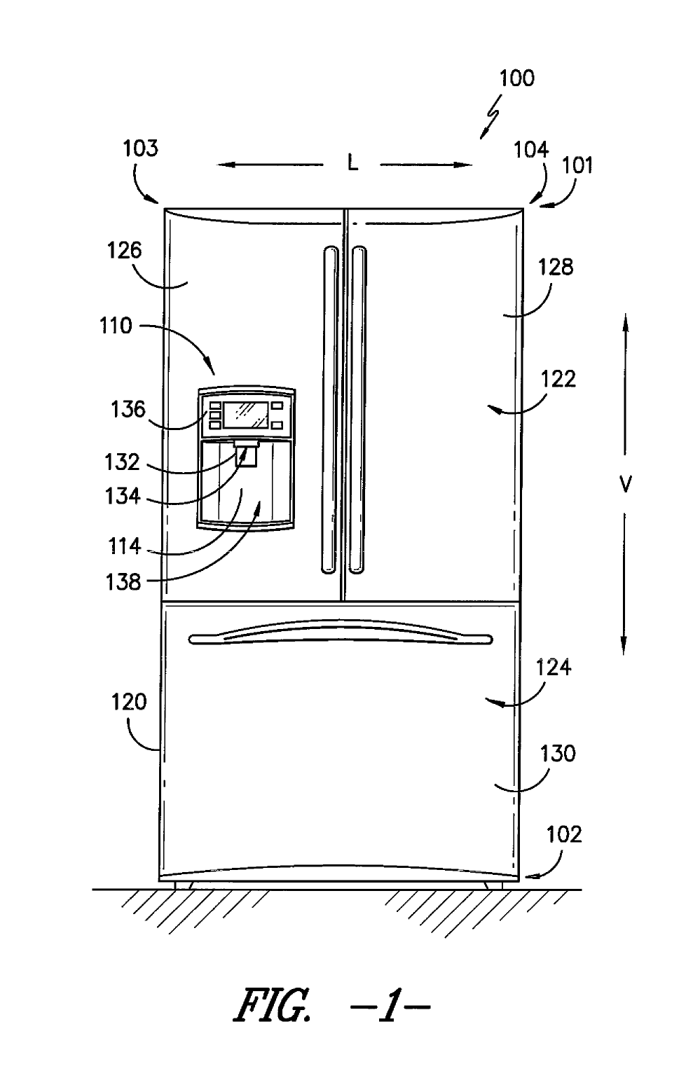

FIG. 1 is a front, elevation view of a refrigerator appliance 100 according to an exemplary embodiment of the present subject matter. Refrigerator appliance 100 extends between a top portion 101 and a bottom portion 102 along a vertical direction V. Refrigerator appliance 100 also extends between a first side portion 105 and a second side portion 106 along a lateral direction L.

Refrigerator appliance 100 includes a cabinet or housing 120 that defines chilled chambers for receipt of food items for storage. In particular, housing 120 defines a fresh food chamber 122 positioned adjacent top portion 101 of refrigerator appliance 100, and a freezer chamber 124 arranged at bottom portion 102 of refrigerator appliance 100. Thus, freezer chamber 124 is disposed below fresh food chamber 122 on the vertical direction V. Housing 120 also defines a mechanical compartment (not shown) for receipt of a sealed cooling system (not shown).

Refrigerator appliance 100 is generally referred to as a bottom mount refrigerator. Using the teachings disclosed herein, one of skill in the art will understand that the present subject matter can be used with other types of refrigerator appliances (e.g., side-by-side style) and other types of appliances, such as freezer appliances, dishwasher appliances, oven appliances, and/or cook-top appliances. Consequently, the description set forth herein is for illustrative purposes only and is not intended to limit the present subject matter in any aspect.

Refrigerator doors 126 and 128 are rotatably hinged to an edge of housing 120 for accessing fresh food compartment 122. A freezer door 130 is arranged below refrigerator doors 126 and 128 for accessing freezer chamber 124. In the exemplary embodiment, freezer door 130 is coupled to a freezer drawer (not shown) slidably coupled within freezer chamber 124.

Refrigerator appliance 100 includes a dispensing assembly 110 for dispensing water and/or ice. Dispensing assembly 110 includes a dispenser 114 positioned on an exterior portion of refrigerator appliance 100. Dispenser 114 includes a discharging outlet 134 for accessing ice and water. A single paddle 132 is mounted below discharging outlet 134 for operating dispenser 114. A user interface panel 136 is provided for controlling the mode of operation. For example, user interface panel 136 includes a water dispensing button (not labeled) and an ice-dispensing button (not labeled) for selecting a desired mode of operation such as crushed or non-crushed ice.

Discharging outlet 134 and paddle 132 are an external part of dispenser 114, and are mounted in a recessed portion 138 defined in an outside surface of refrigerator door 126. Recessed portion 138 is positioned at a predetermined elevation convenient for a user to access ice or water enabling the user to access ice without the need to bend-over and without the need to access freezer chamber 124. In the exemplary embodiment, recessed portion 138 is positioned at a level that approximates the chest level of a user.

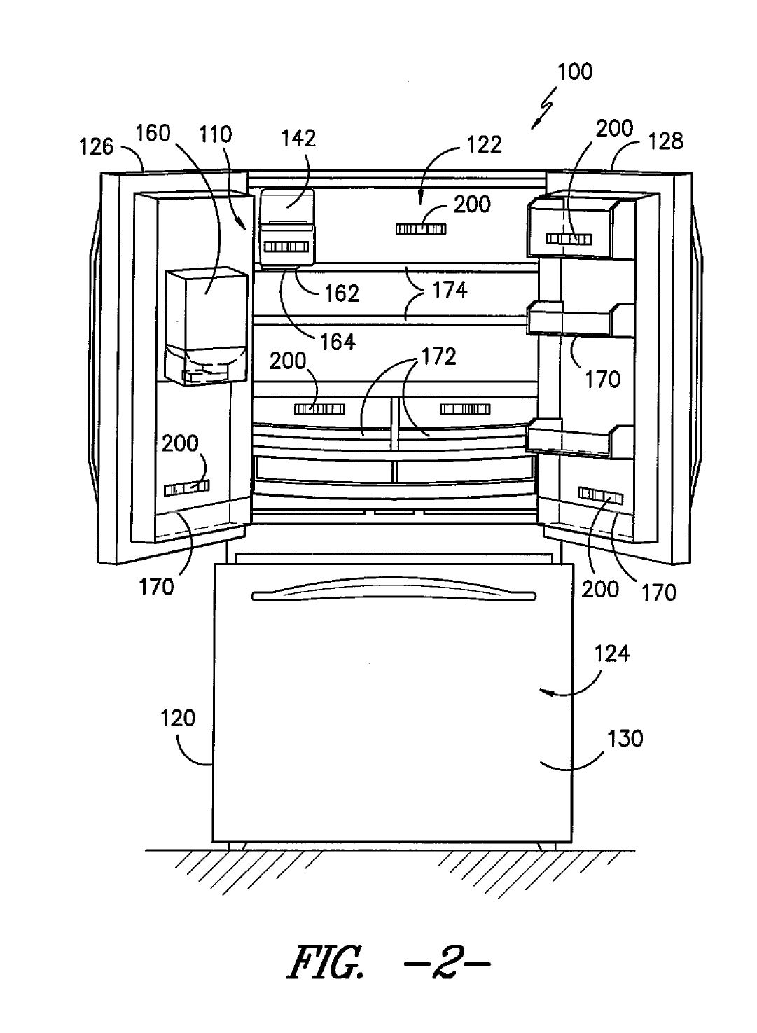

FIG. 2 is a front, elevation view of refrigerator appliance 100 having refrigerator doors 126 and 128 in an open position to reveal fresh food chamber 122. As such, certain components of dispensing assembly 110 are illustrated. Dispensing assembly 110 includes an insulated housing 142 mounted within fresh food chamber 122. Due to the insulation which encloses insulated housing 142, the temperature within insulated housing 142 can be maintained at levels different from the ambient temperature in the surrounding fresh food chamber 122.

The insulated cavity is constructed and arranged to operate at a temperature that facilitates producing and storing ice. More particularly, the insulated cavity contains an ice maker for creating ice and feeding the same to a container 160 that is mounted on refrigerator door 126. As illustrated in FIG. 2, container 160 is placed at a vertical position on refrigerator door 126 that will allow for the receipt of ice from a discharge opening 162 located along a bottom edge 164 of insulated housing 142. As refrigerator door 126 is closed or opened, container 160 is moved in and out of position under insulated housing 142.

Various storage components are also mounted within fresh food chamber 122 to facilitate storage of food items therein as will be understood by those skilled in the art. In particular, the storage components include shelves 170, bins 172, and racks 174 that are mounted within fresh food chamber 122. Shelves 170, bins 172, and racks 174 are configured for receipt of food items (e.g., beverages and/or solid food items) and may assist with organizing such food items. As an example, bins 172 can receive fresh food items (e.g., vegetables, fruits, and/or cheeses) and increase the useful life of such fresh food items.

Refrigerator appliance 100 also includes features for assisting a user with viewing food items within fresh food chamber 122 and/or freezer chamber 124. In particular, a plurality of positional references 200 is mounted within fresh food chamber 122. Positional references 200 are configured for mounting at various locations within fresh food chamber 122 and/or freezer chamber 124 in order to mark or indicate specific locations within the same. As an example, plurality of positional references 200 may include a linear bar code, a matrix or two dimension bar code, or any other suitable positional reference.

Each positional reference of plurality of positional references 200 is mounted at a particular location within fresh food chamber 122. As shown in FIG. 2, one of plurality of positional references 200 is mounted above one of shelves 170. Another of plurality of positional references 200 is mounted on one of bins 172. Yet another one of plurality of positional references 200 is mounted at one of racks 174. As will be understood by those skilled in the art, the distribution of plurality of positional references 200 shown in FIG. 2 is provided by way of example only. In alternative exemplary embodiments plurality of positional references 200 may be distributed within fresh food chamber 122 and/or freezer chamber 124 in any other suitable manner. Plurality of positional references 200 are discussed in greater detail below.

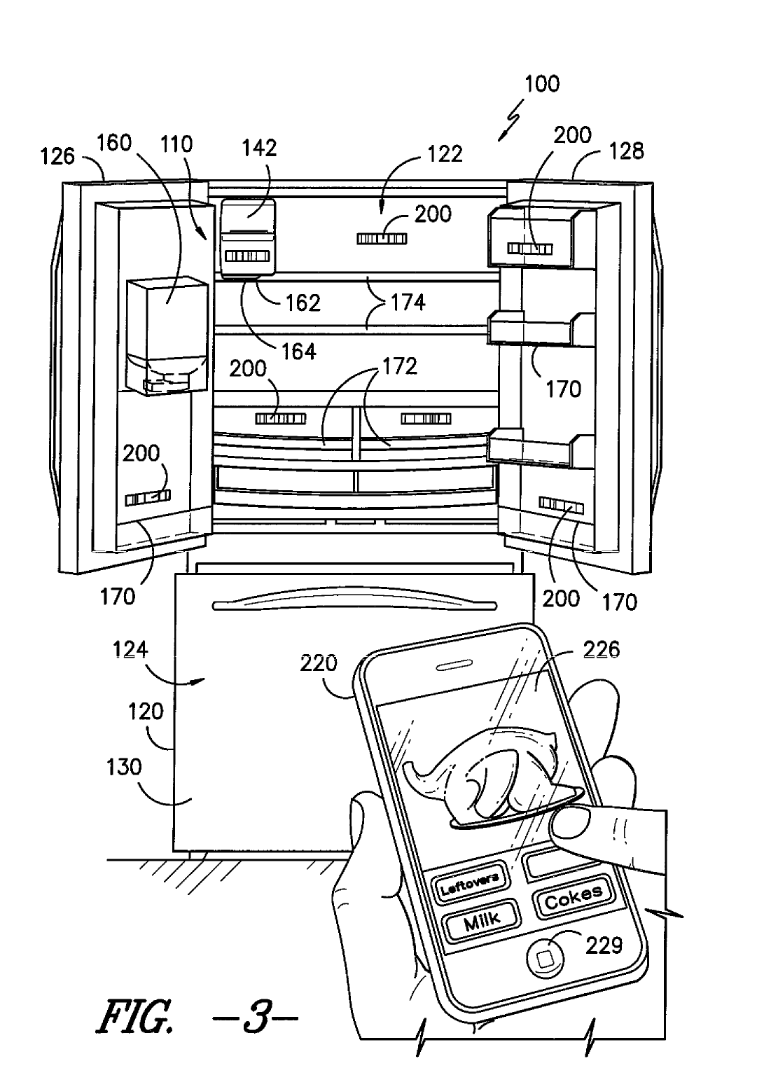

FIG. 3 provides a front elevation view of refrigerator appliance 100 with a mobile device 220 shown directed at refrigerator appliance 100. Mobile device 220 is illustrated as a smartphone in the exemplary embodiment shown in FIG. 3. However, in alternative exemplary embodiments, mobile device 220 can take any appropriate form, such as a personal computer, cell phone, laptop, PDA, tablet, or other computing device. As discussed in greater detail below, mobile device 220 includes appropriate input and output devices, such as a display screen, touch screen, touch pad, data entry keys, speakers, and/or a microphone suitable for voice recognition.

Mobile device 220 is configured for assisting a user with viewing virtual food items within fresh food chamber 122 and/or freezer chamber 124. In particular and as discussed in greater detail below, a user can record an image of fresh food chamber 122 and/or freezer chamber 124 with mobile device 220. Mobile device 220 can modify the image by placing a virtual food item adjacent at least one of plurality of positional references 200 within the image. Mobile device 220 can then display the modified image with the virtual food item, e.g., in order to assist the user seeing how non-virtual food items will fit within fresh food chamber 122 and/or freezer chamber 124.

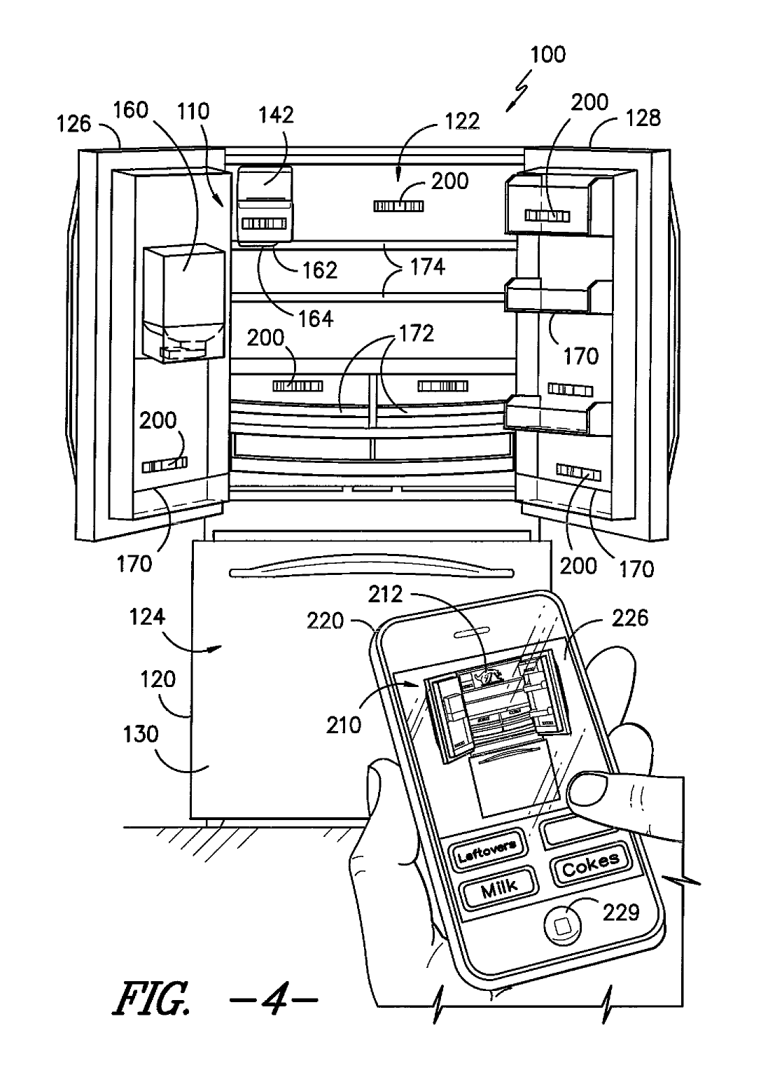

As an example, FIG. 4 provides a front elevation view of refrigerator appliance 100 with mobile device 220 shown displaying a modified image 210 of fresh food chamber 122 of refrigerator appliance 100. Modified image 210 includes a virtual food item 212 positioned within fresh food chamber 122 adjacent one of plurality of positional references 200.

In the exemplary embodiment shown in FIG. 4, virtual food item 212 is shown as a turkey. However, in alternative exemplary embodiments, virtual food item 212 can be any suitable food item, e.g., a case of soda, a container of milk, or a cake. In additional alternative exemplary embodiments, modified image 210 can include a virtual food item at each one of plurality of positional references 200. For example, modified image 210 can display a turkey at one of plurality of positional references 200 and a cake at another of plurality of positional references 200.

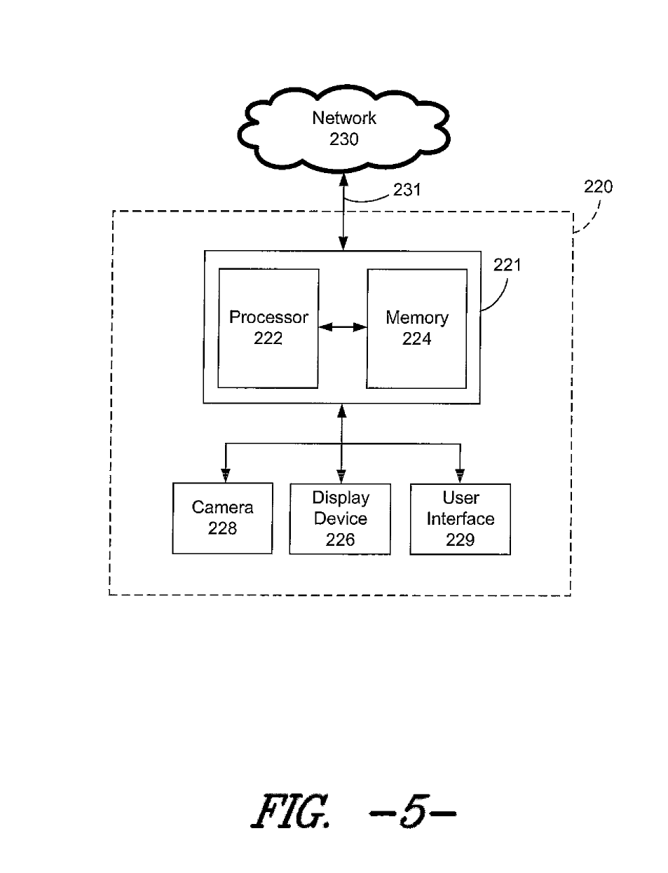

FIG. 5 illustrates a schematic view of mobile device 220. Mobile device 220 includes a controller 221 having at least one processor 222 and a memory 224. Processor 222 can be any known processing device. Memory 224 can include any suitable computer-readable medium or media, including, but not limited to, RAM, ROM, hard drives, flash drives, or other memory devices. Memory 224 stores information accessible by processor 222, including instructions that can be executed by processor 222. The instructions can be any set of instructions that when executed by processor 222, cause processor 222 to provide desired functionality. For instance, the instructions can be software instructions rendered in a computer-readable form. When software is used, any suitable programming, scripting, or other type of language or combinations of languages can be used to implement the teachings contained herein. Alternatively, the instructions can be implemented by hard-wired logic or other circuitry, including, but not limited to application-specific circuits.

In the exemplary embodiment shown in FIG. 5, mobile device 220 also includes a network interface 231 for accessing information over a network 230. Network 230 can include a combination of networks, such as cellular network, WiFi network, LAN, WAN, the Internet, and/or other suitable network and can include any number of wired or wireless communication links. For instance, mobile device 220 can communicate through a cellular network using a WAP standard or other appropriate communication protocol. The cellular network could in turn communicate with the Internet, either directly or through another network.

Mobile device 220 also includes a camera 228, a display device or display 226, and a user interface or user input 229. Controller 221 is in operative communication with camera 228, display device 226, and user interface 229 such that instructions stored in memory 224 and executed by processor 222 can control operation of camera 228, display device 226, and user interface 229. As an example, controller 221 can activate and/or deactivate camera 228 of mobile device 220 as needed or requested by a user.

Camera 228 may be any type of device suitable for capturing an image, such as a still image and/or moving image. As an example, camera 228 may be a video camera or a digital camera with an electronic image sensor, e.g., a charge coupled device (CCD) or a CMOS sensor. Camera 228 is in communication with controller 220 such that controller 220 may receive a signal from camera 228 corresponding to the image captured by camera 228.

Display device 226 is in communication with controller 220 such that display device 226 may receive a signal from controller 220 corresponding to an image captured by camera 228. Display device 226 can receive such signal from controller 220 and present the image to a user visually. Display device 226 may include, for example, a liquid crystal display panel (LCD), a plasma display panel (PDP), or any other suitable mechanism for displaying an image, e.g., a projector.

User interface 229 is configured for permitting a user to manage operation of mobile device 220, e.g., camera 228 and/or display device 226. User interface 229 may include any suitable type of interface such as a touch screen, knobs, sliders, buttons, speech recognition, etc., that permits a user to input control commands for mobile device 220. User interface 229 also allows the user to initiate communications with between mobile device 220 and network 230.

As an example and as discussed in greater detail below, a user can request camera 228 to capture an image of fresh food chamber 122 and at least one of plurality of positional references 200 (FIG. 2). Using the image, controller 221 can determine a transformation matrix relating a coordinate frame of mobile device 220, e.g., camera 228, to a coordinate frame of refrigerator appliance 100, e.g., fresh food chamber 122. Knowing the transformation matrix, controller 221 can render live three-dimensional food items that appear to be located within refrigerator appliance 100 on display device 226.

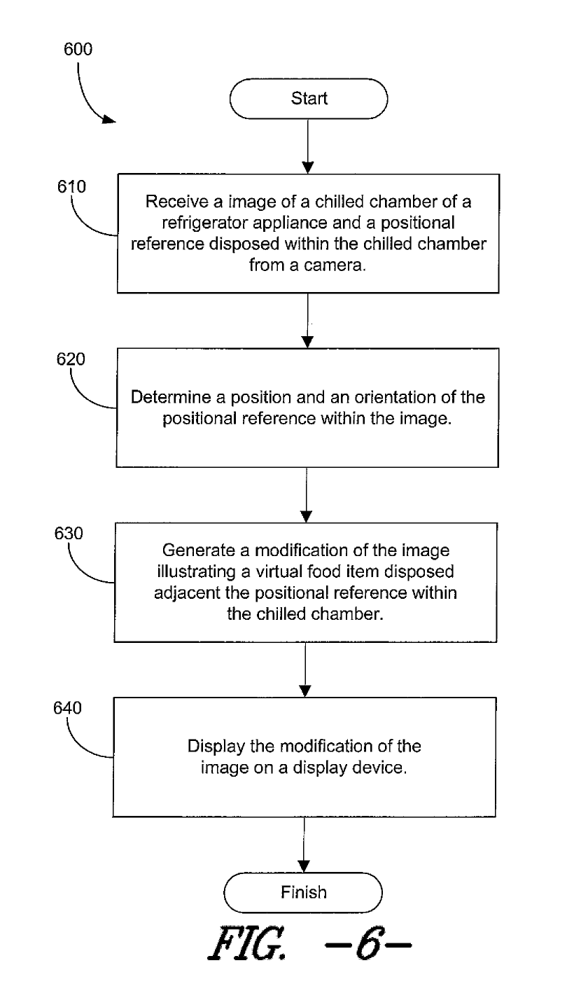

FIG. 6 illustrates a method 600 for viewing virtual food items within a refrigerator appliance, e.g., refrigerator appliance 100, according to an exemplary embodiment of the present subject matter. Method 600 can be implemented or executed by mobile device 220, e.g., controller 221 of mobile device 220 (FIG. 5). For example, method 600, e.g., steps 610, 620, 630, and 640 may be performed as an app on mobile device 220 and in view of the refrigerator appliance. As discussed in greater detail below, utilizing method 600 can assist a user with seeing how non-virtual food items will fit within fresh food chamber 122 and/or freezer chamber 124 (FIG. 2).

At step 610, controller 221 receives an image of fresh food chamber 122 and/or freezer chamber 124 of refrigerator appliance 100 and at least one of plurality of positional references 200 disposed within fresh food chamber 122 and/or freezer chamber 124 from camera 228. As an example, at step 610 a user can direct camera 228 of mobile device 220 towards fresh food chamber 122 and/or freezer chamber 124 and activate camera 228, e.g., with user interface 229. With camera 228 activated, camera 228 sends a signal to controller 221 corresponding to the image produced by camera 228.

At step 620, controller 221 determines a position and an orientation of at least one of plurality of positional references 200 within the image. By determining the position and orientation of at least one of plurality of positional references 200, controller 221 has a known specific location within fresh food chamber 122 and/or freezer chamber 124. Controller 221 can utilize the known specific location to modify the image received at step 610 as discussed in greater detail below.

At step 630, controller 221 generates a modification of the image received at step 610, e.g., by controller 221. The modification of the image illustrates fresh food chamber 122 and/or freezer chamber 124 and a virtual food item disposed adjacent or on at least one of plurality of positional references 200 within fresh food chamber 122 and/or freezer chamber 124. As an example, at step 630, controller 221 can position or illustrate a virtual turkey at a particular one of plurality of positional references 200 within the image.

At step 640, controller 221 presents the modification of the image on display device 226 to a user of mobile device 220. Thus, at step 640, the user can see fresh food chamber 122 and/or freezer chamber 124 on display device 226, and the user can also see the virtual food item on display device 226. By showing the virtual food item on display device 226, method 600 can assist the user with seeing how non-virtual food items fit within fresh food chamber 122 and/or freezer chamber 124.

As an example, large food items, such as turkeys, occupy a large volume within fresh food chamber 122 and/or freezer chamber 124. By showing the user a virtual turkey within fresh food chamber 122 and/or freezer chamber 124 on display device 226 at step 640, method 600 can assist the user with seeing how a non-virtual turkey will fit within fresh food chamber 122 and/or freezer chamber 124. Such information can assist an appliance customer with making an appliance purchase. For example, the appliance customer can have a better understanding of how refrigerator appliance 100 with function within his or her home. Method 600 can also assist with distinguishing refrigerator appliance 100 to the appliance customer. For example, method 600 can assist with marketing refrigerator appliance 100 at a retail store by distinguishing refrigerator appliance 100 from other competing refrigerator appliances.

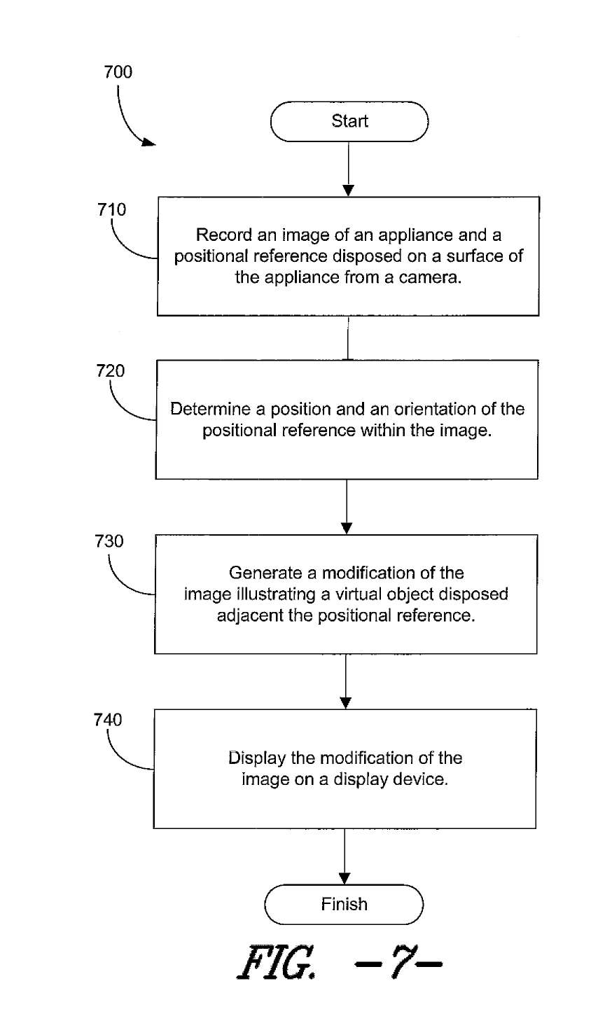

FIG. 7 illustrates a method 700 for viewing virtual objects within an appliance according to an exemplary embodiment of the present subject matter. Method 700 can be implemented or executed by mobile device 220, e.g., controller 221 of mobile device 220 (FIG. 5). As discussed in greater detail below, utilizing method 700 can assist a user with seeing how non-virtual objects will fit within a chamber of an appliance or on a surface of the appliance.

Method 700 is substantially similar to method 600 (FIG. 6). However, method 700 is applicable to additional appliances, such as dishwasher appliances, oven appliances, cooktop appliances, washing machine appliances, and/or dryer appliances. Thus, in method 700, a positional reference can be mounted within a chamber of an appliance or on a surface of the appliance. For example, a positional reference can be mounted within a cooking chamber of an oven appliance, a wash chamber of a dishwasher appliance or a washing machine appliance, a drying chamber of a dryer appliance, or on a cooking surface of a cooktop appliance.

At step 730, controller 221 can generate a modification of a image captured by camera 228 of the chamber or surface of the appliance. The modification can include a virtual object at the positional reference within the chamber or on the surface of the appliance. As an example, the virtual object can be a roast within the cooking chamber of the oven appliance, clothing within the wash chamber of the washing machine appliance or the drying chamber of the dryer appliance, dishes within the wash chamber of the dishwasher appliance, or a pot on the cooking surface of the cooktop appliance. By showing the virtual objects within the modification to a user, e.g., on display device 226, method 700 can assist the user with seeing how corresponding, non-virtual objects fit within or on the appliance.

Method 700, e.g., steps 710, 720, 730, and 740 may be performed by controller 221 of mobile device 220, e.g., as an app on mobile device 220 and in view of the appliance.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for viewing virtual food items within a refrigerator appliance, the refrigerator appliance having a housing that defines a chilled chamber for receipt of food items for storage and a positional reference disposed within the chilled chamber of the refrigerator appliance, the method comprising:
receiving an image of the chilled chamber of the refrigerator appliance and the positional reference disposed within the chilled chamber from a camera;
determining a position and an orientation of the positional reference within the image;
generating a modification of the image, the modification illustrating the chilled chamber of the refrigerator appliance and a virtual food item disposed adjacent the positional reference within the chilled chamber; and
presenting the modification of the image on a display device.

2. The method of claim 1, wherein said step of receiving comprises directing a camera of a mobile device towards the chilled chamber of the refrigerator appliance and the positional reference disposed within the chilled chamber and utilizing the camera to record the image.

3. The method of claim 2, wherein said step of presenting comprises displaying the modification of the image on a display of the mobile device.

4. The method of claim 1, wherein the positional reference comprises a two-dimensional barcode.

5. The method of claim 1, wherein the positional reference comprises a plurality of positional references disposed at various locations within the chilled chamber of the refrigerator appliance.

6. The method of claim 1, wherein the modification of the image illustrates a virtual food item at each positional reference of the plurality of positional references at said step of generating.

7. The method of claim 1, wherein said steps of receiving, generating, and presenting are performed as an app on a mobile device.

8. A system for viewing virtual food items within a refrigerator appliance, the refrigerator appliance having a housing that defines a chilled chamber for receipt of food items for storage and a positional reference disposed within the chilled chamber of the refrigerator appliance, the system comprising:
a mobile device, comprising:
a camera for producing images;
a display for viewing images produced by said camera;
one or more processors; and
at least one memory coupled to the one or more processors, the at least one memory comprising computer-readable instructions for execution by the one or more processors to cause said one or more processors to perform operations, comprising:
recording an image of the chilled chamber of the refrigerator appliance and the positional reference disposed within the chilled chamber with said camera;
determining a position and orientation of the positional reference within the image;
modifying the image by placing a virtual food item adjacent the positional reference within the image; and
displaying the modified image with the virtual food item on said display.

9. The system of claim 8, wherein said mobile device comprises a smartphone or a tablet computer.

10. The system of claim 8, wherein the positional reference comprises a two-dimensional barcode.

11. The system of claim 8, wherein the positional reference comprises a plurality of positional references disposed at various locations within the chilled chamber of the refrigerator appliance.

12. The system of claim 11, wherein the modified image illustrates a virtual food item at each positional reference of the plurality of positional references at said step of modifying.

13. The system of claim 11, wherein the refrigerator appliance includes shelves, racks, and bins positioned within the chilled chamber of the refrigerator appliance for storing food items, each positional reference of the plurality of positional references being positioned at a respective one of the shelves, racks, and bins.

14. The system of claim 8, wherein the virtual food item comprises one of a turkey, a milk container, and a case of soda.

15. A computer-readable medium having computer-readable instruction for execution by a processor, causing the processor to perform the operations of:
receiving an image an appliance and a positional reference disposed on a surface of the appliance from a camera;
determining a position and an orientation of the positional reference within the image;
generating a modification of the image, the modification illustrating the appliance and a virtual object disposed adjacent the positional reference; and
presenting the modification of the image on a display device.

16. The computer-readable medium of claim 15, wherein the camera is coupled to a mobile device.

17. The computer-readable medium of claim 16, wherein the display device is coupled to the mobile device.

18. The computer-readable medium of claim 15, wherein the positional reference comprises a two-dimensional barcode.

19. The computer-readable medium of claim 15, wherein the positional reference comprises a plurality of positional references disposed at various locations within the chamber of the appliance.

20. The computer-readable medium of claim 19, wherein said step of generating comprises modifying the image such that the modification illustrates a virtual object at each positional reference of the plurality of positional references.
